(19) United States
(12) Patent Application Publication
(10) Pub. No.: US 2013/0075409 A1
(43) Pub. Date: Mar. 28, 2013

(54) FUEL CONTAINERS MADE FROM POLYETHYLENE COMPOSITIONS WITH IMPROVED CREEP RESISTANCE

(71) Applicants: Mridula Kapur, Lake Jackson, TX (US); Stephanie M. Whited, Charleston, WV (US); Josef J. Van Dun, Zandhoven (BE)

(72) Inventors: Mridula Kapur, Lake Jackson, TX (US); Stephanie M. Whited, Charleston, WV (US); Josef J. Van Dun, Zandhoven (BE)

(21) Appl. No.: 13/635,692

(22) PCT Filed: Apr. 13, 2011
(86) PCT No.: PCT/US11/32341

§ 371 Date: Dec. 12, 2012

Related U.S. Application Data
(60) Provisional application No. 61/324,199, filed on Apr. 14, 2010.

(51) Int. Cl. B60K 15/03; C08L 23/04

(52) U.S. Cl. CPC B60K 15/03177; C08L 23/04
USPC 220/562; 264/540; 525/53

(57) ABSTRACT

Fuel containers made from polyethylene compositions exhibiting improved creep resistance are provided. The polyethylene compositions include two components, a first component ethylene-based interpolymer, and a second component ethylene-based polymer. A process for producing a fuel container from the polyethylene compositions by blow molding is also provided. The fuel containers may include vehicle fuel tanks.

### FIELD OF INVENTION

The invention relates to hydrocarbon and fuel containers made from high density polyethylene (“HDPE”) compositions exhibiting improved creep resistance and stiffness, while maintaining good toughness, stress cracking resistance and blow moldability. The invention further relates to product applications utilizing such HDPE compositions.

### BACKGROUND OF THE INVENTION

Certain applications for high density polyethylene resins subject the polymer to abnormal conditions including for example high temperatures and pressures and exposure to petroleum products. Such applications include for example fuel storage containers, hydrocarbon storage containers, vehicle fuel tanks, pressure pipe, hot water pipe, geomembranes, and steel pipe coatings.

One application of particular interest is the use of HDPE to manufacture fuel tanks for use in automobiles. Automobile fuel tanks are subjected to both high temperatures and pressures under both normal and unusual operating conditions. The recirculation of diesel fuel may increase the temperature in the diesel fuel tank up to about 60° C. Moreover, the fuel tank in hybrid electrical vehicles is generally intermittently closed during driving, thereby causing the pressure and temperature in the tank to increase significantly, up to about 300 mbar at 60° C. for gasoline. Further, off-road driving, extreme driving or weather conditions can cause the temperature and pressure in the tank to increase significantly.

The stresses imparted on the fuel tank by pressure and temperature have been addressed by increasing the number of reinforcing ribs or the wall thickness of the tanks. However, such measures increase fuel tank cost and weight which impacts overall fuel efficiency and cost.

Fuel tanks made from current polymers typically undergo deformation as a result of aging in the fuel environment. In particular, the bottom section of the tank undergoes deformation due to polymer swelling and the weight of the fuel. This requires the fuel tank producer to use brackets or braces to maintain a guaranteed clearance between the tank and the ground.

Automobile fuel tanks are required to exhibit high safety performance, particularly with regard to fire resistance and impact resistance. They are required to meet minimum statutory industry specific performance criteria both with respect to creep resistance when the tank is subjected to a fire and crash test resistance when the tank is subjected to an impact. An automobile fuel tank for use in Europe is required to have a fire resistance and an impact resistance both complying with the respective standards defined in ECE34, Annex 5. In order to meet these standards, known blow molded automobile fuel tanks are required to have a minimum wall thickness of at least 3 mm so as to provide sufficient impact strength and creep resistance for the fuel tank as a whole. An automobile fuel tank composed of polyethylene typically has a volume of up to about 100 liters, or even greater. The requirement for such volumes in combination with the need for progressively lower wall thicknesses places a high demand on the physical properties of the walls of the tank, both following manufacture and during end use. Thus the walls of the fuel tank are required not to warp or shrink following their manufacture, and are required to have a precisely defined shape and rigidity during use.

Hydrocarbon containers and fuel containers for non-automobile applications likewise frequently require improved physical characteristics and may be subject to various statutory and/or industry requirements. Accordingly, hydrocarbon and fuel containers exhibiting good environmental stress crack resistance (ESCR), creep resistance and impact resistance would be desirable.

### SUMMARY OF THE INVENTION

Certain embodiments of the invention provide a fuel container comprising a polyethylene composition comprising a first component comprising an ethylene-based interpolymer, wherein the first component is a heterogeneously branched linear or a homogeneously branched linear ethylene-based interpolymer, having a density from 0.922 g/cc to 0.945 g/cc, and a high load melt index I₂₁ between 0.1 and 1 g/10 min; and a second component comprising an ethylene-based polymer fraction, wherein the polyethylene composition has a density in the range of from 0.937 to 0.960 g/cc and a high load melt index I₂₁ in the range of from 3 to 15 g/10 min.

Other embodiments of the invention provide a fuel container comprising a polyethylene composition consisting essentially of a first component comprising an ethylene-based interpolymer, wherein the first component is a heterogeneously branched linear or a homogeneously branched linear ethylene-based interpolymer, having a density from 0.922 g/cc to 0.945 g/cc, and a high load melt index I₂₁ between 0.1 and 1 g/10 min; and a second component comprising an ethylene-based polymer fraction, wherein the polyethylene composition has a density in the range of from 0.937 to 0.960 g/cc and a high load melt index I₂₁ in the range of from 3 to 15 g/10 min.

In specific embodiments of the invention, the polyethylene composition exhibits an average creep strain, measured according to ASTM D2990 at 60° C. and 2 MPa, of less than or equal to 1.8 percent. In some embodiments, the polyethylene composition exhibits an environmental stress crack resistance F50 greater than 1000 hours determined according to ASTM D1693, method B, in 10 percent aqueous Igepal (Octylphenoxy Poly(Ethyleneoxy)Ethanol, Branched) CO-630 solution, a Charpy Impact measured according to ISO-179 at −40° C. of at least 18 kJ/m², and a tensile modulus measured according to ASTM D638 of at least 105,000 psi.

In some embodiments of the invention, the first component is an ethylene/α-olefin interpolymer. In certain embodiments, the first component is an ethylene/α-olefin interpolymer and the α-olefin is selected from the group consisting of 1-butene, 1-pentene, 1-hexene, 1-heptene, 1-octene, 1-nonene, and 1-decene.

In some embodiments of the invention, the first component comprises between 50 wt % and 70 wt % of based on the total weight of the polyethylene composition. In some embodiments, the polyethylene composition has a density in the range of from 0.945 to 0.958 g/cc. In some embodiments, the polyethylene composition has a high load melt index I₂₁ in the range of from 3 to 8 g/10 min. In certain instances, the fuel container is made from a polyethylene composition which further includes one or more additives selected from the group consisting of fillers, UV stabilizers, and pigments. In specific embodiments, the fuel container is a vehicle fuel tank.

Another aspect of the invention provides a process for blow molding a polyethylene composition into a fuel container comprising extruding a polyethylene composition having a density in the range of from 0.937 to 0.960 g/cc and a high load melt index I₂₁ in the range of from 3 to 15 g/10 min and comprising a first component comprising an ethylene-based interpolymer, wherein the first component is a heterogeneously branched linear or a homogeneously branched linear ethylene-based interpolymer, having a density from 0.922 g/cc to 0.945 g/cc, and a high load melt index I₂₁ between 0.1 and 1 g/10 min and a second heterogeneously branched linear or a homogeneously branched linear ethylene-based interpolymer or homopolymer component and optionally a filler, in an extruder through a die; forming a molten tube-shaped parison; holding the parison within a shaping mold; blowing a gas into the mold so as to shape the parison according to a profile of the mold; and to yield a blow molded article in a shape for use as a fuel container.

Another aspect of the invention provides a process for blow molding a polyethylene composition into a fuel container consisting essentially of extruding a polyethylene composition having a density in the range of from 0.937 to 0.960 g/cc and a high load melt index I₂₁ in the range of from 3 to 15 g/10 min and comprising a first component comprising an ethylene-based interpolymer, wherein the first component is a heterogeneously branched linear or a homogeneously branched linear ethylene-based interpolymer, having a density from 0.922 g/cc to 0.945 g/cc, and a high load melt index I₂₁ between 0.1 and 1 g/10 min and a second heterogeneously branched linear or a homogeneously branched linear ethylene-based interpolymer or homopolymer component and optionally a filler, in an extruder through a die; forming a molten tube-shaped parison; holding the parison within a shaping mold; blowing a gas into the mold so as to shape the parison according to a profile of the mold; and to yield a blow molded article in a shape for use as a fuel container.

Yet another aspect of the invention provides a method for preparing a polyethylene composition comprising a first component ethylene-based interpolymer and a second component ethylene-based polymer (interpolymer or homopolymer), said method comprising: a) polymerizing either the first component ethylene-based interpolymer, or the second component ethylene-based polymer (interpolymer or homopolymer), in a first reactor, in the presence of a Ziegler-Natta catalyst system, to form a first polymer product; b) transferring the first polymer product to a second reactor; and c) polymerizing, in the second reactor, the ethylene-based polymer that was not produced in the first reactor, in the presence of the Ziegler-Natta catalyst system; wherein the first component ethylene-based interpolymer is a heterogeneously branched linear ethylene-based interpolymer, and has a density from 0.922 g/cc to 0.945 g/cc, and a high load melt index (I₂₁) from 0.1 g/10 min to 1 g/10 min; and wherein the polyethylene composition has a density in the range of from 0.937 to 0.960 g/cc and a high load melt index I₂₁ in the range of from 3 to 15 g/10 min.

Yet another aspect of the invention provides a method for preparing a polyethylene composition comprising a first component ethylene-based interpolymer and a second component ethylene-based polymer (interpolymer or homopolymer) consisting essentially of a) polymerizing either the first component ethylene-based interpolymer, or the second component ethylene-based polymer (interpolymer or homopolymer), in a first reactor, in the presence of a Ziegler-Natta catalyst system, to form a first polymer product; b) transferring the first polymer product to a second reactor; and c) polymerizing, in the second reactor, the ethylene-based polymer that was not produced in the first reactor, in the presence of the Ziegler-Natta catalyst system; wherein the first component ethylene-based interpolymer is a heterogeneously branched linear ethylene-based interpolymer, and has a density from 0.922 g/cc to 0.945 g/cc, and a high load melt index (I₂₁) from 0.1 g/10 min to 1 g/10 min; and wherein the polyethylene composition has a density in the range of from 0.937 to 0.960 g/cc and a high load melt index I₂₁ in the range of from 3 to 15 g/10 min.

In yet another aspect, the invention provides for articles, each comprising at least one component formed from an inventive composition as described herein.

### DETAILED DESCRIPTION OF THE INVENTION

The invention provides a polyethylene composition that can be used in the fabrication of fuel tanks with improved properties.

In addition, the inventive compositions can be azide modified to form fuel tanks with better sag and SCG (slow crack growth) resistance, over conventional Cr based resins.

The invention provides a new polyethylene composition for making fuel tanks by molding processes, for example, the blow molding of fuel tanks.

The invention provides a composition comprising a first component ethylene-based interpolymer and a second component ethylene-based polymer (interpolymer or homopolymer), and wherein the first component polyethylene-based interpolymer is a heterogeneously branched linear or a homogeneously branched linear ethylene-based interpolymer, and has a density from 0.922 g/cc to 0.945 g/cc, and a high load melt index (I₂₁) from 0.1 g/10 min to 1 g/10 min, and wherein the second component ethylene-based polymer (interpolymer or homopolymer) is heterogeneously branched linear or a homogeneously branched linear ethylene-based polymer (interpolymer or homopolymer), and has a density from 0.940 g/cc to 0.980 g/cc, and a melt index, I₂, from 200 g/10 min to 1500 g/10 min.

In another embodiment, the first component ethylene-based interpolymer has a density from 0.922 g/cc to 0.940 g/cc.

In another embodiment, the composition has a density from 0.937 g/cc to 0.960 g/cc. In another embodiment, the composition has a density less than 0.960 g/cc. In another embodiment, the composition has a density less than, or equal to, 0.958 g/cc.

In another embodiment, the composition has a high load melt index, I₂₁, from 3 to 15 g/10 min, and a density greater than 0.9375 g/cc. In another embodiment, the composition has a high load melt index, I₂₁, from 4 to 8 g/10 min.

In another embodiment, the first component ethylene-based interpolymer is a heterogeneously branched linear interpolymer. In another embodiment, the second component ethylene-based interpolymer is a heterogeneously branched linear interpolymer.

In another embodiment, the second component ethylene-based polymer (interpolymer or homopolymer) has a melt index (I₂) from 200 g/10 min to 1500 g/10 min. In another embodiment, the first component ethylene-based interpolymer is present in an amount from 50 to 70 weight percent (calculated split %), based on the sum weight of the first component ethylene-based interpolymer and the second component ethylene-based polymer (interpolymer or homopolymer).

In another embodiment, the composition has less than 0.5 vinyl unsaturations/1000 carbon (1000/C), preferably less than 0.4 vinyls/1000 carbon, and more preferably less than 0.3 vinyls/1000 carbon.

In some embodiments the composition has an extrudate capillary swell t_{300 av} of less than or equal to 25, less than or equal to 20 or less than or equal to 17. Such low swell compositions allow greater flexibility for molding articles from the compositions.

In yet another embodiment, the first component ethylene-based interpolymer is an ethylene/α-olefin interpolymer. In a further embodiment, the α-olefin is selected from the group consisting of C3 to C10 α-olefins. In yet a further embodiment, the α-olefin is preferably propylene, 1-butene, 1-pentene, 1-hexene, 1-heptene, 1-octene, 1-nonene and 1-decene, and more preferably propylene, 1-butene, 1-hexene and 1-octene, and even more preferably 1-hexene.

In another embodiment, the second component ethylene-based polymer is either a homopolymer of ethylene of an interpolymer ethylene with one or more α-olefins. In a further embodiment, the α-olefin is selected from the group consisting of C3 to C10 α-olefins. In yet a further embodiment, the α-olefin is selected from the group consisting propylene, 1-butene, 1-pentene, 1-hexene, 1-heptene, 1-octene, 1-nonene and 1-decene, and more preferably propylene, 1-butene, 1-hexene and 1-octene, and even more preferably 1-hexene.

An inventive composition may have a combination of two or more embodiments as described herein.

In another embodiment, the invention provides a polyethylene composition consisting essentially of a first component ethylene-based interpolymer and a second component ethylene-based polymer (interpolymer or homopolymer), and wherein the first component polyethylene-based interpolymer is a heterogeneously branched linear or a homogeneously branched linear ethylene-based interpolymer, and has a density from 0.922 g/cc to 0.945 g/cc, and a high load melt index (I₂₁) from 0.1 g/10 min to 1 g/10 min, and wherein the second component ethylene-based polymer (interpolymer or homopolymer) is heterogeneously branched linear or a homogeneously branched linear ethylene-based polymer (interpolymer or homopolymer), and has a density from 0.940 g/cc to 0.980 g/cc, and a melt index, I₂, from 200 g/10 min to 1500 g/10 min.

The invention also provides for an article comprising at least one component formed from an inventive composition.

In one embodiment, the article, or the at least one component thereof, is made of an inventive composition having a Charpy Impact, at −40° C., greater than, or equal to, 18 kJ/m², as determined by ISO 179.

In one embodiment, the article, or the at least one component thereof, is made of an inventive composition having an environmental stress crack resistance F50 value greater than 1000 hours determined according to ASTM D1693, method B, in 10 percent aqueous Igepal (Octylphenoxy Poly(Ethyleneoxy)Ethanol, Branched) CO-630 solution.

In another embodiment, the article or at least one component thereof, is made of an inventive composition having a tensile modulus greater than, or equal to, 105,000 psi as determined by ASTM D638.

In another embodiment, the article, or the at least one component thereof, is made of an inventive composition exhibiting a creep strain, measured according to ASTM D2990 at 60° C. and 2 MPa on compression molded samples, of less than or equal to 1.8 percent

In another embodiment, the article is a blow molded article. An inventive article may have a combination of two or more embodiments as described herein.

The invention also provides a method of preparing a composition comprising a first component ethylene-based interpolymer and a second component ethylene-based interpolymer, said method comprising: a) polymerizing either the first component ethylene-based interpolymer or the second component ethylene-based interpolymer, in a first reactor, in the presence of a Ziegler-Natta catalyst system, to form a first interpolymer product; b) transferring the first interpolymer product to another reactor; and c) polymerizing, in the other reactor, the ethylene-based interpolymer that was not produced in the first reactor, in the presence of the Ziegler-Natta catalyst system; and wherein the first component ethylene-based interpolymer is a heterogeneously branched linear ethylene-based interpolymer, and has a density from 0.922 g/cc to 0.945 g/cc, and a high load melt index (I₂₁) from 0.1 g/10 min to 1 g/10 min, and wherein the second component ethylene-based interpolymer is a heterogeneously branched linear ethylene-based interpolymer, and has a density from 0.940 g/cc to 0.980 g/cc, and a melt index (I₂) from 200 g/10 min to 1500 g/10 min. In one embodiment, the polymerizations take place in at least two reactors. In another embodiment, the polymerizations take place in two reactors. In another embodiment, at least one reactor is a gas phase reactor.

The invention also provides a method of preparing a composition comprising a first component ethylene-based interpolymer and a second component ethylene-based interpolymer, said method consisting essentially of a) polymerizing either the first component ethylene-based interpolymer or the second component ethylene-based interpolymer, in a first reactor, in the presence of a Ziegler-Natta catalyst system, to form a first interpolymer product; b) transferring the first interpolymer product to another reactor; and c) polymerizing, in the other reactor, the ethylene-based interpolymer that was not produced in the first reactor, in the presence of the Ziegler-Natta catalyst system; and wherein the first component ethylene-based interpolymer is a heterogeneously branched linear ethylene-based interpolymer, and has a density from 0.922 g/cc to 0.945 g/cc, and a high load melt index (I₂₁) from 0.1 g/10 min to 1 g/10 min, and wherein the second component ethylene-based interpolymer is a heterogeneously branched linear ethylene-based interpolymer, and has a density from 0.940 g/cc to 0.980 g/cc, and a melt index (I₂) from 200 g/10 min to 1500 g/10 min. In one embodiment, the polymerizations take place in at least two reactors. In another embodiment, the polymerizations take place in two reactors. In another embodiment, at least one reactor is a gas phase reactor.

In another embodiment, catalyst is fed only into a first reactor.

In another embodiment, the polymerization of the first component ethylene-based interpolymer and/or the second component ethylene-based interpolymer takes place in a gas phase polymerization.

In another embodiment, the polymerization of the first component ethylene-based interpolymer and/or the second component ethylene-based interpolymer takes place in a slurry polymerization.

In another embodiment, the polymerization of the first component ethylene-based interpolymer and the second component ethylene-based interpolymer each takes place in a gas phase reactor, and wherein the reactors are operated in series.

In a further embodiment, no additional catalyst is added to the second reactor.

In another embodiment, the polymerization of the first component ethylene-based interpolymer and/or the second component ethylene-based interpolymer takes place in a gas phase/slurry polymerization combination.

In another embodiment, the polymerization of the first component ethylene-based interpolymer and/or the second component ethylene-based interpolymer takes place in the presence of a Ziegler-Natta catalyst.

In another embodiment, the polymerization of the first component ethylene-based interpolymer and/or the second component ethylene-based interpolymer takes place in the presence of a metallocene catalyst.

In another embodiment, the polymerization of the first component ethylene-based interpolymer and/or the second component ethylene-based interpolymer takes place in the presence of a metal compound selected from the group consisting of vanadium metal compound, zirconium metal compound, hafnium metal compound and titanium metal compound.

In another embodiment, the gas phase polymerization takes place in the presence of an induced condensing agent, and wherein the dew point of the cycle gas is less than the inlet temperature of the recycle gas. In a further embodiment, the induced condensing agent is isopentane or hexane.

The invention also provides a method of preparing an inventive composition, said method comprising polymerizing the first component ethylene-based interpolymer and the second component ethylene-based interpolymer in one reactor, and in the presence of two Ziegler-Natta catalyst systems.

The invention also provides a method of preparing an inventive composition, said method comprising: a) polymerizing a first component ethylene-based interpolymer and a second component ethylene-based interpolymer in a first reactor, and in the presence of two Ziegler-Natta catalyst systems to form a first polymer product; b) transferring the first polymer product to a second reactor; and c) polymerizing further the first polymer product in the second reactor.

The invention also provides a method of preparing an inventive composition, said method comprising: a) polymerizing a first component ethylene-based interpolymer or a second component ethylene-based interpolymer in a first reactor and in the presence of a first Ziegler-Natta catalyst system, to form a first polymer product; b) transferring the first polymer product to a second reactor; and c) polymerizing, in the second reactor, the ethylene-based interpolymer that was not produced in the first reactor, in the presence of a second Ziegler-Natta catalyst system.

The invention further provides a process for blow molding a polyethylene composition into a fuel container comprising extruding a polyethylene composition having a density in the range of from 0.937 to 0.960 g/cc and a high load melt index I₂₁ in the range of from 3 to 15 g/10 min and comprising a first component comprising an ethylene-based interpolymer, wherein the first component is a heterogeneously branched linear or a homogeneously branched linear ethylene-based interpolymer, having a density from 0.922 g/cc to 0.945 g/cc, and a high load melt index I₂₁ between 0.1 and 1 g/10 min and a second heterogeneously branched linear or a homogeneously branched linear ethylene-based interpolymer or homopolymer component and optionally a filler, in an extruder through a die; forming a molten tube-shaped parison; holding the parison within a shaping mold; blowing a gas into the mold so as to shape the parison according to a profile of the mold; and to yield a blow molded article in a shape for use as a fuel container.

Another aspect of the invention provides a process for blow molding a polyethylene composition into a fuel container consisting essentially of extruding a polyethylene composition having a density in the range of from 0.937 to 0.960 g/cc and a high load melt index I₂₁ in the range of from 3 to 15 g/10 min and comprising a first component comprising an ethylene-based interpolymer, wherein the first component is a heterogeneously branched linear or a homogeneously branched linear ethylene-based interpolymer, having a density from 0.922 g/cc to 0.945 g/cc, and a high load melt index I₂₁ between 0.1 and 1 g/10 min and a second heterogeneously branched linear or a homogeneously branched linear ethylene-based interpolymer or homopolymer component and optionally a filler, in an extruder through a die; forming a molten tube-shaped parison; holding the parison within a shaping mold; blowing a gas into the mold so as to shape the parison according to a profile of the mold; and to yield a blow molded article in a shape for use as a fuel container.

An inventive method may have a combination of two or more embodiments as described herein.

Further details of the embodiments of the invention are described below.

### Polymer Composition

The inventive compositions contain a first component ethylene-based interpolymer and a second component polyethylene-based polymer (homopolymer or interpolymer). Additional features of these components are described below.

### The First Component

The first component ethylene-based interpolymer has a density greater than, or equal to, 0.922 g/cc, preferably greater than, or equal to, 0.9225 g/cc, and more preferably greater than, or equal to, 0.923 g/cc. In another embodiment, the first component ethylene-based interpolymer has a density less than, or equal to, 0.945 g/cc, preferably less than, or equal to, 0.942 g/cc, and more preferably less than, or equal to 0.940 g/cc.

The first component ethylene-based interpolymer has a high load melt index, I₂₁, (190° C., 21.6 kg weight, ASTM 1238) greater than, or equal to, 0.10, preferably greater than, or equal to, 0.15, and more preferably greater than, or equal to, 0.20 (units of grams per 10 minutes). In another embodiment, the first component ethylene-based interpolymer has a high load melt index, I₂₁, less than, or equal to, 1, preferably less than, or equal to, 0.8, and more preferably less than, or equal to, 0.7 (units of grams per 10 minutes).

In another embodiment, the first component ethylene-based interpolymer is an ethylene/α-olefin interpolymer. In one embodiment, the α-olefin is a C3-C20 α-olefin, a C4-C20 α-olefin, and more preferably a C4-C12 α-olefin, and even more preferably a C4-C8 α-olefin, and most preferably C6-C8 α-olefin.

The term “interpolymer,” as used herein, refers to a polymer having polymerized therein at least two monomers. It includes, for example, copolymers, terpolymers and tetrapolymers. As discussed above, the term “interpolymer” particularly includes a polymer prepared by polymerizing ethylene with at least one comonomer, typically an α-olefin of 3 to 20 carbon atoms (C3-C20), or 4 to 20 carbon atoms (C4-C20), or 4 to 12 carbon atoms (C4-C12) or 4 to 8 carbon atoms (C4-C8), or 6 to 8 carbon atoms (C6-C8). The α-olefins include, but are not limited to, propylene 1-butene, 1-pentene, 1-hexene, 1-heptene, and 1-octene. Preferred α-olefins include propylene, 1-butene, 1-pentene, 1-hexene, 4-methyl-1-pentene, 1-heptene, and 1-octene. Especially preferred α-olefins include 1-hexene and 1-octene, and more preferably 1-hexene. The α-olefin is desirably a C3-C10 α-olefin, and more desirably a C3-C8 α-olefin, and most desirably C6-C8 α-olefin.

Interpolymers include ethylene/butene (EB) copolymers, ethylene/hexene-1 (EH), ethylene/octene-1 (EO) copolymers, ethylene/α-olefin/diene modified (EAODM) interpolymers such as ethylene/propylene/diene modified (EPDM) interpolymers and ethylene/propylene/octene terpolymers. Preferred copolymers include EB, EH and EO copolymers, and most preferably EH and EO copolymers.

In a preferred embodiment, the first component ethylene-based interpolymer is an ethylene/1-hexene interpolymer. In a further embodiment, the ethylene/1-hexene copolymer is produced using a hexene/ethylene (C6/C2) molar ratio from 0.005:1 to 0.105:1. In yet a further embodiment, the ethylene/1-hexene copolymer is produced using a hydrogen/ethylene (H2/C2) molar ratio from 0.01:1 to 0.09:1.

The first component may comprise a combination of two or more embodiments as described herein.

### The Second Component

The second component ethylene-based polymer (homopolymer or interpolymer) has a density greater than, or equal to, 0.940 g/cc, preferably greater than, or equal to, 0.942 g/cc, and more preferably greater than, or equal to, 0.945 g/cc. In another embodiment, the second component ethylene-based polymer has a density less than or equal to 0.980 g/cc.

The term “homopolymer,” as used herein, refers to a polymer having 1 weight % or less comonomer and 99 weight % or more ethylene monomer.

In another embodiment, the second component ethylene-based polymer is an ethylene/α-olefin interpolymer. In some embodiments, the α-olefin is a C3-C20 α-olefin, a preferably a C4-C20 α-olefin, and more preferably a C4-C12 α-olefin, and even more preferably a C4-C8 α-olefin and most preferably C6-C8 α-olefin. Preferred α-olefins include propylene, 1-butene, 1-pentene, 1-hexene, 4-methyl-1-pentene, 1-heptene, and 1-octene. Especially preferred α-olefins include 1-hexene and 1-octene, and more preferably 1-hexene. The α-olefin is desirably a C3-C8 α-olefin, and more desirably a C4-C8 α-olefin and most desirably a C6-C8 α-olefin.

Interpolymers include ethylene/butene-1 (EB) copolymers, ethylene/hexene-1 (EH), ethylene/octene-1 (EO) copolymers, ethylene/α-olefin/diene modified (EAODM) interpolymers such as ethylene/propylene/diene modified (EPDM) interpolymers and ethylene/propylene/octene terpolymers. Preferred copolymers include EB, EH and EO copolymers, and most preferred copolymers are EH and EO.

In a preferred embodiment, the second component is a homopolymer or ethylene/1-hexene copolymer. In a further embodiment, the second component is produced using a hexene/ethylene (C6/C2) molar ratio from 0 to 0.02. In yet a further embodiment, the ethylene/1-hexene copolymer is produced using a hydrogen/ethylene (H2/C2) molar ratio from 0.6 to 3.0. In yet a further embodiment, the second component ethylene-based polymer is a linear polymer.

The second component may comprise a combination of two or more embodiments as described herein.

In a preferred embodiment, the second component is determined by operating at a known set of reactor conditions to produce the desired component melt index and density. These conditions are determined by producing the second component ethylene-based polymer separately to determine the appropriate reactor conditions, i.e., temperature, H2/C2 and C6/C2 ratios, which would result in a second component having the desired melt index and density. Such determined reactor conditions may then be used in a second reactor in series to produce a second component having the desired melt index and density.

One preferred process for producing the second component alone is as follows:

Ethylene is copolymerized with 1-hexene in a fluidized bed reactor. The polymerization is continuously conducted after equilibrium is reached, under the respective conditions (A, B or C), as set forth in Table 1.

TABLE 1

| | A | B | C |
|---|---|---|---|
| REACTION CONDITIONS | | | |
| Temperature ° C. | 110 | 100 | 103 |
| Pressure, psig | 398 | 398 | 398 |
| C2 Part. Pressure, psi | 95 | 95 | 95 |
| H2/C2 Molar Ratio | 1.80 | 1.80 | 1.20 |
| C6/C2 Molar Ratio | 0.004 | 0.000 | 0.002 |
| Isopentane, mole % | 0.493 | 0.49 | 0.721 |
| Production Rate, lb/hr | 26.5 | 31.5 | 38.5 |
| Residence Time, hr | 3.6 | 3.1 | 2.5 |
| RESIN PROPERTIES | | | |
| Melt Index, dg/min I₂ | 1245 | 478 | 246 |
| Density, g/cc | 0.9717 | 0.9739 | 0.9715 |

Polymerization is initiated by continuously feeding the catalyst and cocatalyst into a fluidized bed of polyethylene granules, together with ethylene, 1-hexene and hydrogen. Inert gases, nitrogen and isopentane, make up the remaining pressure in the reactors. By repeating this process for a wide range of operating conditions resulting in a wide range of melt index and density ethylene/1-hexene copolymer, a model could then be developed, and used to control the melt index and density of the copolymer in a second reactor in series. Likewise, such models could be created for other homopolymers and interpolymers.

As discussed above the first component ethylene-based interpolymer and the second component ethylene-based polymer are each a linear ethylene-based polymer, and preferably a heterogeneously branched linear or a homogeneously branched linear ethylene-based interpolymer. The term “linear ethylene-based interpolymer,” as used herein, refers to an interpolymer that lacks long-chain branching, or lacks measurable amounts of long chain branching, as determined by techniques known in the art, such as NMR spectroscopy (for example ¹³C NMR as described by Randall, Rev. Macromal. Chem. Phys., C29 (2&3), pp. 285-293, incorporated herein by reference). Long-chain branched interpolymers are described in U.S. Pat. Nos. 5,272,236 and 5,278,272, the disclosures of which are incorporated herein by reference. As is known in the art, the heterogeneously branched linear and homogeneously branched linear interpolymers have short chain branching due to the incorporation of comonomer into the growing polymer chain.

The homogeneously branched linear ethylene interpolymers are ethylene interpolymers, which lack long chain branching (or measurable amounts of long chain branching), but do have short chain branches, derived from the comonomer polymerized into the interpolymer, and in which the comonomer is homogeneously distributed, both within the same polymer chain, and between different polymer chains.

The heterogeneously branched linear ethylene interpolymers are ethylene interpolymers, which lack long chain branching (or measurable amounts of long chain branching), but do have short chain branches, derived from the comonomer polymerized into the interpolymer, and in which the comonomer is heterogeneously distributed between different polymer chains.

In a preferred embodiment, the inventive composition has a high load melt index, I₂₁, (190° C., 21.6 kg weight, ASTM 1238) greater than, or equal to, 3, preferably greater than, or equal to, 3.5, and more preferably greater than, or equal to, 4 (g/10 min). In another embodiment, the inventive composition has a high load melt index, I₂₁, less than, or equal to, 15, preferably less than, or equal to, 12, and more preferably less than, or equal to, 10.

In yet another embodiment, the high load melt index, I₂₁, of the inventive composition ranges from 3 to 15 grams per 10 minutes, and preferably in the range from 3.5 to 12 g/10 min, and more preferably in the range from 4 to 10 g/10 min.

In another embodiment, the first component ethylene-based interpolymer is present in an amount less than, or equal to 70 weight percent, preferably less than, or equal to 68 weight percent, and more preferably less than, or equal to 65 weight percent, based on the sum weight of the first component ethylene-based interpolymer and the second component ethylene-based polymer.

In another embodiment, the second component ethylene-based interpolymer is present in an amount greater than, or equal to 30 weight percent, preferably greater than, or equal to 32 weight percent, and more preferably greater than, or equal to 35 weight percent, based on the sum weight of the first component ethylene-based interpolymer and the second component ethylene-based polymer. In another embodiment, the weight ratio of the first component to the second component is from 70/30 to 50/50, and more preferably from 65/35 to 55/45.

The inventive composition may comprise a combination of two or more embodiments as described herein.

Typical transition metal catalyst systems, which can be used to prepare the inventive compositions, are Ziegler-Natta catalyst systems, such as magnesium/titanium based catalyst systems, such as those described in U.S. Pat. No. 4,302,565, incorporated herein by reference, as well as PCT Publication serial nos. WO 2006/023057 and WO 2005/012371, each of which is incorporated herein by reference.

In some embodiments, the preferred catalysts used to make the inventive compositions are of the magnesium/titanium type. In particular, for gas phase polymerizations, the catalyst is made from a precursor comprising magnesium and titanium chlorides in an electron donor solvent. This solution is often either deposited on a porous catalyst support, or a filler is added, which, on subsequent spray drying, provides additional mechanical strength to the particles. The solid particles from either support methods are often slurried in a diluent, producing a high viscosity mixture, which is then used as catalyst precursor. Exemplary catalyst types are described in U.S. Pat. No. 6,187,866 and U.S. Pat. No. 5,290,745, each of which is incorporated herein by reference. Other exemplary catalysts include precipitated/crystallized catalyst systems, such as those described in U.S. Pat. No. 6,511,935 and U.S. Pat. No. 6,248,831, each of which is incorporated herein by reference.

In one embodiment, the catalyst precursor has the formula Mg_{d}Ti(OR)ₑX_{f} (ED)_{g}, wherein R is an aliphatic or aromatic hydrocarbon radical having 1 to 14 carbon atoms or COR′, wherein R′ is a aliphatic or aromatic hydrocarbon radical having 1 to 14 carbon atoms; each OR group is the same or different; X is independently chlorine, bromine or iodine; ED is an electron donor; d is 0.5 to 56; e is 0, 1, or 2; f is 2 to 116; and g is >2 and up to 1.5*d+3. Such a precursor is prepared from a titanium compound, a magnesium compound, and an electron donor.

The electron donor is an organic Lewis base, liquid at temperatures in the range of about 0° C. to about 200° C., and in which the magnesium and titanium compounds are soluble. The electron donor compounds are sometimes also referred to as Lewis bases.

The electron donor can be an alkyl ester of an aliphatic or aromatic carboxylic acid, an aliphatic ketone, an aliphatic amine, an aliphatic alcohol, an alkyl or cycloalkyl ether, or mixtures thereof, and each electron donor having 2 to 20 carbon atoms. Among these electron donors, the preferred are alkyl and cycloalkyl ethers having 2 to 20 carbon atoms; dialkyl, diaryl, and alkylaryl ketones having 3 to 20 carbon atoms; and alkyl, alkoxy, and alkylalkoxy esters of alkyl and aryl carboxylic acids having 2 to 20 carbon atoms. The most preferred electron donor is tetrahydrofuran. Other examples of suitable electron donors are methyl formate, ethyl acetate, butyl acetate, ethyl ether, dioxane, di-n-propyl ether, dibutyl ether, ethanol, 1-butanol, ethyl formate, methyl acetate, ethyl anisate, ethylene carbonate, tetrahydropyran, and ethyl propionate.

While a large excess of electron donor may be used initially to provide the reaction product of titanium compound and electron donor, the final catalyst precursor contains about 1 to about 20 moles of electron donor per mole of titanium compound, and preferably about 1 to about 10 moles of electron donor per mole of titanium compound.

Since the catalyst will act as a template for the growth of the polymer, it is essential that the catalyst precursor be converted into a solid. It is also essential that the resultant solid has the appropriate particle size and shape to produce polymer particles with relatively narrow size distribution, low amounts of fines and good fluidization characteristics. Although this solution of Lewis Base, magnesium and titanium compounds may be impregnated into a porous support, and dried to form a solid catalyst, it is preferred that the solution be converted into a solid catalyst via spray drying. Each of these methods thus forms a “supported catalyst precursor.” The spray dried catalyst product is then, preferentially placed into mineral oil slurry.

The viscosity of the hydrocarbon slurry diluent is sufficiently low, so that the slurry can be conveniently pumped through the pre-activation apparatus, and eventually into the polymerization reactor. The catalyst is fed using a slurry catalyst feeder. A progressive cavity pump, such as a Moyno pump, is typically used in commercial reaction systems, while a dual piston syringe pump is typically used in pilot scale reaction systems, where the catalyst flows are less than, or equal to, 10 cm³/hour (2.78×10-9 m³/s) of slurry.

A cocatalyst, or activator, is also fed to the reactor to effect the polymerization.

Complete activation by additional cocatalyst is required to achieve full activity.

The complete activation normally occurs in the polymerization reactor, although the techniques taught in EP 1,200,483, incorporated herein by reference, may also be used.

The cocatalysts, which are reducing agents, are typically comprised of aluminum compounds, but compounds of lithium, sodium and potassium, alkaline earth metals, as well as compounds of other earth metals, other than aluminum are possible.

The compounds are usually hydrides, organometal or halide compounds. Butyl lithium and dibutyl magnesium are examples of useful compounds.

An activator compound, which is generally used with any of the titanium based catalyst precursors, can have the formula AlRₐX_{b}H_{c}, wherein each X is independently chlorine, bromine, iodine, or OR′; each R and R′ is independently a saturated aliphatic hydrocarbon radical having 1 to 14 carbon atoms; b is 0 to 1.5; c is 0 or 1; and a+b+c=3. Preferred activators include alkylaluminum mono- and dichlorides, wherein each alkyl radical has 1 to 6 carbon atoms, and the trialkylaluminums. Examples are diethylaluminum chloride and tri-n-hexylaluminum. About 0.10 moles to about 10 moles, and preferably about 0.15 moles to about 2.5 moles, of activator are used per mole of electron donor. The molar ratio of activator to titanium is in the range of about 1:1 to about 10:1, and is preferably in the range of about 2:1 to about 5:1.

The hydrocarbyl aluminum cocatalyst can be represented by the formula RAl or RAlX, wherein each R is independently alkyl, cycloalkyl, aryl, or hydrogen; at least one R is hydrocarbyl; and two or three R radicals can be joined to form a heterocyclic structure. Each R, which is a hydrocarbyl radical, can have 1 to 20 carbon atoms, and preferably has 1 to 10 carbon atoms. X is a halogen, preferably chlorine, bromine, or iodine. Examples of hydrocarbyl aluminum compounds are as follows: triisobutylaluminum, tri-n-hexylaluminum, di-isobutyl-aluminum hydride, dihexylaluminum hydride, di-isobutylhexylaluminum, isobutyl dihexylaluminum, trimethylaluminum, triethylaluminum, tripropylaluminum, triisopropylaluminum, tri-n-butylaluminum, trioctylaluminum, tridecylaluminum, tridodecylaluminum, tribenzylaluminum, triphenylaluminum, trinaphthylaluminum, tritolylaluminum, dibutylaluminum chloride, diethylaluminum chloride, and ethylaluminum sesquichloride. The cocatalyst compounds can also serve as activators and modifiers.

Activators can be added to the precursor either before and/or during polymerization. In one procedure, the precursor is fully activated before polymerization. In another procedure, the precursor is partially activated before polymerization, and activation is completed in the reactor. Where a modifier is used, instead of an activator, the modifiers are usually dissolved in an organic solvent, such as isopentane. Where a support is used, the modifier is typically impregnated into the support, following impregnation of the titanium compound or complex, after which the supported catalyst precursor is dried. Otherwise, the modifier solution is added by itself directly to the reactor. Modifiers are similar in chemical structure and function to the activators, as are cocatalysts. U.S. Pat. No. 5,106,926, the disclosure of which is incorporated herein by reference, discusses such alternative procedures. The cocatalyst is preferably added separately neat, or as a solution in an inert solvent, such as isopentane, to the polymerization reactor at the same time as the flow of ethylene is initiated.

In those embodiments that use a support, the precursor is supported on an inorganic oxide support, such as silica, aluminum phosphate, alumina, silica/alumina mixtures, silica that has been modified with an organoaluminum compound, such as triethyl aluminum, and silica modified with diethyl zinc. In some embodiments silica is a preferred support. A typical support is a solid, particulate, porous material essentially inert to the polymerization. It is used as a dry powder having an average particle size of about 10 μm to about 250μ, and preferably about 30 μm to about 100 μm; a surface area of at least 200 m²/g and preferably at least about 250 m²/g; and a pore size of at least about 100×10⁻¹⁰ m and preferably at least about 200×10⁻¹⁰ m. Generally, the amount of support used, is that which will provide about 0.1 millimole to about 1.0 millimole of titanium per gram of support, and preferably about 0.4 millimole to about 0.9 millimole of titanium per gram of support. Impregnation of the above mentioned catalyst precursor into a silica support can be accomplished by mixing the precursor and silica gel in the electron donor solvent, or other solvent, followed by solvent removal under reduced pressure. When a support is not desired, the catalyst precursor can be used in liquid form.

The polyethylene composition may be rheology modified, also known as coupled, by polyfunctional sulfonyl azides, as disclosed in U.S. Pat. No. 6,521,306 and PCT Publication No. WO 2006065651A2, each of which are incorporated herein by reference.

### Polymerization

In a preferred dual reactor configuration, the catalyst precursor and the cocatalyst are introduced in the first reactor, and the polymerizing mixture is transferred to the second reactor for further polymerization. Insofar as the catalyst system is concerned, only cocatalyst, if desired, is added to the second reactor from an outside source. Optionally the catalyst precursor may be partially activated prior to the addition to the reactor (preferably the first reactor), followed by further “in reactor activation” by the cocatalyst.

In the preferred dual reactor configuration, the first component is prepared in the first reactor. Alternatively, the second component can be prepared in the first reactor, and the first component can be prepared in the second reactor. For purposes of the present disclosure, the reactor, in which the conditions are conducive to making the first component polymer is known as the “first component reactor.” Likewise, the reactor in which the conditions are conducive to making the second component polymer is known as the “second component reactor.” Irrespective of which component is made first, the mixture of polymer and an active catalyst is preferably transferred from the first reactor to the second reactor, via an interconnecting device, using nitrogen, or second reactor recycle gas, as a transfer medium.

The polymerization in each reactor is preferably conducted in the gas phase using a continuous fluidized bed process. In a typical fluidized bed reactor, the bed is usually made up of the same granular resin that is to be produced in the reactor. Thus, during the course of the polymerization, the bed comprises formed polymer particles, growing polymer particles, catalyst particles fluidized by polymerization, and modifying gaseous components, introduced at a flow rate or velocity sufficient to cause the particles to separate and act as a fluid. The fluidizing gas is made up of the initial feed, make-up feed, and cycle (recycle) gas, that is, comonomers, and, if desired, modifiers and/or an inert carrier gas.

A typical fluid bed system includes a reaction vessel, a bed, a gas distribution plate, inlet and outlet piping, a compressor, cycle gas cooler, and a product discharge system. In the vessel, above the bed, there is a velocity reduction zone, and, in the bed, a reaction zone. Both are above the gas distribution plate. A typical fluidized bed reactor is further described in U.S. Pat. No. 4,482,687, incorporated herein by reference.

The gaseous feed streams of ethylene, other gaseous α-olefins, and hydrogen, when used, are preferably fed to the reactor recycle line, as well as liquid or gaseous α-olefins and the cocatalyst solution. Optionally, the liquid cocatalyst can be fed directly to the fluidized bed. The partially activated catalyst precursor is preferably injected into the fluidized bed as a mineral oil slurry. Activation is generally completed in the reactors by the cocatalyst. The product composition can be varied by changing the molar ratios of the monomers introduced into the fluidized bed. The product is continuously discharged in granular or particulate form from the reactor, as the bed level builds up with polymerization. The production rate is controlled by adjusting the catalyst feed rate and/or the ethylene partial pressures in both reactors.

A preferred mode is to take batch quantities of product from the first reactor, and transfer these to the second reactor using the differential pressure generated by the recycle gas compression system. A system similar to that described in U.S. Pat. No. 4,621,952, which is incorporated herein by reference, is particularly useful.

The pressure is about the same in both the first and second reactors. Depending on the specific method used to transfer the mixture of polymer and contained catalyst from the first reactor to the second reactor, the second reactor pressure may be either higher than, or somewhat lower than, that of the first. If the second reactor pressure is lower, this pressure differential can be used to facilitate transfer of the polymer catalyst mixture from Reactor 1 to Reactor 2. If the second reactor pressure is higher, the differential pressure across the cycle gas compressor may be used as the motive force to move polymer. The pressure, that is, the total pressure in either reactor, can be in the range of about 200 to about 500 psig (pounds per square inch gauge), and is preferably in the range of about 270 to about 450 psig (1.38, 3.45, 1.86 and 3.10 MPa, respectively). The ethylene partial pressure in the first reactor can be in the range of about 10 to about 150 psi, (pounds per square inch) and is preferably in the range of about 20 to about 80 psi, and more preferably is in the range of about 25 to about 60 psi, (68.9, 1034, 138, 552, 172 and 414 MPa, respectively). The ethylene partial pressure in the second reactor is set according to the amount of copolymer to be produced in this reactor, to achieve the appropriate split. It is noted that increasing the ethylene partial pressure in the first reactor leads to an increase in ethylene partial pressure in the second reactor. The balance of the total pressure is provided by α-olefin other than ethylene and an inert gas such as nitrogen. Other inert hydrocarbons, such as an induced condensing agent, for example, isopentane or hexane, also contribute to the overall pressure in the reactor, according to their vapor pressure, under the temperature and pressure experienced in the reactor.

The hydrogen:ethylene mole ratio can be adjusted to control average molecular weights. The α-olefins (other than ethylene) can be present in a total amount of up to 15 percent by weight of the copolymer, and, if used, are preferably included in the copolymer in a total amount from about 0.5 to about 10 percent by weight, or more preferably from about 0.8 to about 4 percent by weight, based on the weight of the copolymer.

The residence time of the mixture of reactants including gaseous and liquid reactants, catalyst, and resin, in each fluidized bed can be in the range from about 1 to about 12 hours, and is preferably in the range from about 1.5 to about 5 hours.

The reactors can be run in the condensing mode, if desired. The condensing mode is described in U.S. Pat. No. 4,543,399, U.S. Pat. No. 4,588,790 and U.S. Pat. No. 5,352,749, each of which is incorporated herein by reference.

The inventive polyethylene compositions are preferably produced in the gas phase by various low pressure processes. The inventive compositions can also be produced in the liquid phase in solutions or slurries by conventional techniques, again at low pressures.

Low pressure processes are typically run at pressures below 1000 psi, whereas high pressure processes are typically run at pressures above 15,000 psi (6.89 and 103 MPa, respectively).

As discussed above, in a dual reactor system, the first component or the second component can be prepared in the first reactor or second reactor. Dual reactor systems include, but are not limited to, two gas phase fluidized bed reactors in series, two stirred tank reactors in series, two loop reactors in series, two solution spheres or loops in series, or a suitable combination of two reactors.

For the reaction of interest, appropriate comonomer amounts, ethylene partial pressures, and temperatures will be adjusted to produce the desired composition. Such adjustments can be made by those skilled in the art.

### First Component Reactor Operation Conditions

In an embodiment suitable for fuel tank polymers, operating temperature can range from 70° C. to 110° C. The mole ratio of α-olefin to ethylene in this reactor can be in the range of from 0.005:1 to 0.105:1, and is preferably in the range of from 0.01:1 to 0.1:1 and most preferably from 0.010:1 to 0.095:1. The mole ratio of hydrogen (if used) to ethylene in this reactor can be in the range of from 0.01:1 to 0.09:1, preferably of from 0.02:1 to 0.07:1.

### Second Component Reactor Operation Conditions

In an embodiment suitable for fuel tank polymers, the operating temperature is generally in the range from 70° C. to 115° C. The mole ratio of α-olefin to ethylene can be in the range from 0 to 0.02:1, preferably in the range from 0:1 to 0.01:1. The mole ratio of hydrogen to ethylene can be in the range from 0.6:1 to 3:1, and is preferably in the range from 1.4:1 to 2.2:1.

### Fabricated Articles

The compositions of the present invention can be used to manufacture a shaped article, or one or more components of a shaped article. Such articles may be single-layer or a multi-layer articles, which are typically obtained by suitable known conversion techniques, applying heat, pressure, or a combination thereof, to obtain the desired article. Suitable conversion techniques include, for example, blow-molding, co-extrusion blow-molding, compression molding, and thermoforming. Shaped articles include, but are not limited to, fuel tanks.

The compositions according to the present invention are particularly suitable for durable applications, especially blow molded fuel tanks, without the need for cross-linking. Blow molded fuel tanks include monolayer fuel tanks, as well as multilayer fuel tanks, including multilayer composite fuel tanks.

Typically, the fuel tanks of the invention are formed from inventive compositions, which also contain a suitable combination of additives, such as, an additive package designed for fuel tanks applications, and/or one or more fillers.

Monolayer fuel tanks, according to the present invention, consist of one layer made from a composition according to the present invention, and suitable additives typically used, or suitable for, fuel tank applications. As discussed above, such additives typically include colorants and materials suitable to protect the bulk polymer from specific adverse environmental effects, for example, oxidation during extrusion, or degradation under service conditions. Suitable additives include process stabilizers, antioxidants, pigments, catalyst residue and metal de-activators, additives to improve chlorine resistance, and UV protectors.

Preferred multilayer composite fuel tanks include one or more (e.g., one or two) layers, and wherein at least one layer comprises an inventive composition. In another embodiment, the multilayered fuel tanks will further comprise a barrier layer and/or an adhesive layer. It is to be understood that such a multilayer composite fuel tank may be made of any suitable moldable material such as polymeric material, e.g., high density polyethylene (HDPE) or polypropylene. Moreover, the fuel tank may include a single layer or may be multi-layered as desired for reduced permeation as describe in U.S. Pat. No. 6,722,521, which is incorporated herein by reference.

For example, the fuel tank may be made of a multi-layered wall including layers of polyethylene and a low permeation ethylene-vinyl alcohol (EVOH) co-polymer. In this example, the multi-layer wall may be a polyethylene-EVOH wall having a continuous inner polymeric layer, a continuous outer polymeric layer, and an EVOH copolymer layer disposed between the inner and outer polymeric layers. The continuous inner polymeric layer may be made, for example, of high density polyethylene (HDPE) and may also include carbon black compounded with the HDPE therein. Alternatively, the continuous inner polymeric layer may be made of any other suitable materials known in the art. Moreover, the outer polymeric layer may be placed in overlying relationship with the continuous inner polymeric layer. The outer polymeric layer may be made of HDPE and may also include carbon black compounded with the HDPE therein. The outer polymeric layer may further include regrind of the fuel tank production surplus. Alternatively, the outer polymeric layer may be made of any other suitable materials. The multi-layer wall further includes a first adhesive layer disposed between the continuous inner polymeric layer and the low permeation ethylene-vinyl alcohol (EVOH) co-polymer barrier layer. In some embodiments, the first adhesive layer is a low density polyethylene (LDPE), such as an ethylene-α-maleic anhydride co-polymer. The first adhesive layer bonds the low permeation barrier layer to the continuous inner polymeric layer. Moreover, in some embodiments, a second adhesive layer may be disposed between the second low permeation barrier layer and the outer polymeric layer. Typically, the second adhesive layer is also made of LDPE such as ethylene-α-maleic anhydride co-polymer. The second adhesive layer bonds the second low permeation barrier layer to the outer polymeric layer. Thus, the low permeation barrier layer, the first adhesive layer and the second adhesive layer are disposed in the space between the inner polymeric layer and the outer polymeric layer.

The fuel tank may be formed using extrusion apparatus, twin-sheet thermo-forming, or blow molding techniques. Of course, other suitable methods of forming fluid tank may be used without falling beyond the scope or spirit of the present invention.

In another embodiment, the rheology modified compositions of the invention, such as the azide-coupled compositions, are particularly useful in fabricating automotive fuel tanks, including for example, gasoline tanks and diesel tanks Azide-coupled compositions useful in certain embodiments of the invention include those disclosed in U.S. Pat. No. 6,521,306 and PCT Publication No. WO2006065651, the disclosures of which is incorporated herein by reference.

A blow molded article of the present invention may be manufactured by blow molding the abovementioned coupled polymer composition through the use of a conventional blow molding machine, preferably an extrusion blow molding machine, employing conventional conditions. For example, in the case of extrusion blow molding, the resin temperature is typically between about 180° C. and 250° C. The above mentioned coupled polymer composition having a proper temperature is extruded through a die in the form of a molten tube-shaped parison. Next the parison is held within a shaping mold. Subsequently a gas, preferably air, nitrogen or carbon dioxide, or fluorine for improved barrier performance properties, is blown into the mold, so as to shape the parison according to the profile of the mold, yielding a hollow molded article.

Adequate parison sag resistance and polymer melt strength is necessary for producing acceptable blow molded articles, especially large blow molded articles such as fuel tanks. If the polymer's melt strength is too low, the weight of the parison can cause elongation of the parison, causing problems, such as variable wall thickness and weight in the blow molded article, part blow-out, neck down, and the like. Too high of a melt strength can result in rough parisons, insufficient blowing, excessive cycle times and the like.

Any numerical range recited herein, includes all values from the lower value and the upper value, in increments of one unit, provided that there is a separation of at least two units between any lower value and any higher value. As an example, if it is stated that a compositional, physical or other property, such as, for example, molecular weight, melt index, is from 100 to 1,000, it is intended that all individual values, such as 100, 101, 102, etc., and sub ranges, such as 100 to 144, 155 to 170, 197 to 200, etc., are expressly enumerated in this specification. For ranges containing values which are less than one, or containing fractional numbers greater than one (e.g., 1.1, 1.5, etc.), one unit is considered to be 0.0001, 0.001, 0.01 or 0.1, as appropriate. For ranges containing single digit numbers less than ten (e.g., 1 to 5), one unit is typically considered to be 0.1. These are only examples of what is specifically intended, and all possible combinations of numerical values between the lowest value and the highest value enumerated, are to be considered to be expressly stated in this application.

Numerical ranges have been recited, as discussed herein, in reference to density, melt index, weight percent of component and other properties.

### Test Methods

Resin density was measured by the Archimedes displacement method, ASTM D 792, Method B, in isopropanol. Specimens were measured within 1 hour of molding, after conditioning in the isopropanol bath at 23° C. for 8 minutes to achieve thermal equilibrium prior to measurement. The specimens were compression molded according to ASTM D4703, Annex A, with a 5 min initial heating period at about 190° C. (+2° C.) and a 15° C./min cooling rate per Procedure C. The specimen was cooled to 45° C. in the press, with continued cooling until “cool to the touch.”

Melt flow rate measurements were performed according to ASTM D1238, Condition 190° C./2.16 kg, Condition 190° C./5 kg and Condition 190° C./21.6 kg, which are known as I₂, I₅ and I₂₁, respectively. I₂₁ is referred to herein as the high load melt index. Melt flow rate is inversely proportional to the molecular weight of the polymer. Thus, the higher the molecular weight, the lower the melt flow rate, although the relationship is not linear. Melt Flow Ratio (MFR) is the ratio of melt flow rate (I₂₁) to melt flow rate (I₅), unless otherwise specified.

Gel Permeation Chromatography (GPC)

Polymer molecular weight was characterized by high temperature triple detector gel permeation chromatography (3D-GPC). The chromatographic system consisted of a Waters (Milford, Mass.) 150° C. high temperature chromatograph, equipped with a Precision Detectors (Amherst, Mass.) 2-angle laser light scattering (LS) detector, Model 2040, and a 4-capillary differential viscometer detector, Model 150R, from Viscotek (Houston, Tex.). The 15° angle of the light scattering detector was used for calculation purposes. Concentration was measured via an infra-red detector (IR4) from PolymerChar, Valencia, Spain.

Data collection was performed using Viscotek TriSEC software version 3 and a 4-channel Viscotek Data Manager DM400. The Carrier solvent was 1,2,4-trichlorobenzene (TCB). The system was equipped with an on-line solvent degas device from Polymer Laboratories. The carousel compartment was operated at 150° C., and the column compartment was operated at 150° C. The columns were four Polymer Laboratories Mixed-A 30 cm, 20 micron columns. The reference polymer solutions were prepared in TCB. The inventive and comparative samples were prepared in decalin. The samples were prepared at a concentration of 0.1 grams of polymer in 50 ml of solvent. The chromatographic solvent (TCB) and the sample preparation solvent (TCB or decalin) contained 200 ppm of butylated hydroxytoluene (BHT). Both solvent sources were nitrogen sparged. Polyethylene samples were stirred gently at 160° C. for 4 hours. The injection volume was 200 μl, and the flow rate was 1.0 ml/minute.

The preferred column set is of 20 micron particle size and “mixed” porosity gel to adequately separate the highest molecular weight fractions appropriate to the claims.

Calibration of the GPC column set was performed with 21 narrow molecular weight distribution polystyrene standards. The molecular weights of the standards ranged from 580 to 8,400,000 g/mol, and were arranged in 6 “cocktail” mixtures, with at least a decade of separation between individual molecular weights.

The polystyrene standard peak molecular weights were converted to polyethylene molecular weights using the following equation (as described in Williams and Ward, J. Polym. Sci., Polym. Let., 6, 621 (1968)):

Mpolyethylene=A×(Mpolystyrene)^{B} (1A),

Where M is the molecular weight, A has a cited value of 0.4316, and B is equal to 1.0. An alternative value of A, herein referred to as “q” or as a “q factor”, was experimentally determined to be 0.39. The best estimate of “q” was determined using the predetermined weight average molecular weight of a broad linear polyethylene homopolymer (Mw˜115,000 g/mol, Mw/Mn˜3.0). Said weight average molecular weight was obtained in a manner consistent with that published by Zimm (Zimm, B. H., J. Chem. Phys., 16, 1099 (1948)) and Kratochvil (Kratochvil, P., Classical Light Scattering from Polymer Solutions, Elsevier, Oxford, N.Y. (1987)). The response factor, K_{LS}, of the laser detector was determined using the certificated value for the weight average molecular weight of NIST 1475 (52,000 g/mol). The method for obtaining the alternative “q factor” is described in more detail below.

A fourth order polynomial was used to fit the respective polyethylene-equivalent calibration points obtained from equation 1A to their observed elution volumes. The actual polynomial fit was obtained so as to relate the logarithm of polyethylene equivalent molecular weights to the observed elution volumes (and associated powers) for each polystyrene standard.

The total plate count of the GPC column set was performed with Eicosane (prepared at 0.04 g in 50 milliliters of TCB, and dissolved for 20 minutes with gentle agitation.) The plate count and symmetry were measured on a 200 microliter injection according to the following equations:

PlateCount=5.54*(RV at Peak Maximum/(Peak width at ½ height))² (2A),

where RV is the retention volume in milliliters, and the peak width is in milliliters.

Symmetry=(Rear peak width at one tenth height−RV at Peak maximum)/(RV at Peak Maximum−Front peak width at one tenth height) (3A),

where RV is the retention volume in milliliters, and the peak width is in milliliters.

The plate count for the chromatographic system (based on eicosane as discussed previously) should be greater than 22,000, and symmetry should be between 1.00 and 1.12.

The Systematic Approach for the determination of each detector offset was implemented in a manner consistent with that published by Balke, Mourey, et. Al (Mourey and Balke, Chromatography Polym. Chpt 12, (1992)) (Balke, Thitiratsakul, Lew, Cheung, Mourey, Chromatography Polym. Chpt 13, (1992)), using data obtained from the three detectors while analyzing the broad linear polyethylene homopolymer (115,000 g/mol) and the narrow polystyrene standards. The Systematic Approach was used to optimize each detector offset to give molecular weight results as close as possible to those observed using the conventional GPC method. The overall injected concentration, used for the determinations of the molecular weight and intrinsic viscosity, was obtained from the sample infra-red area, and the infra-red detector calibration (or mass constant) from the linear polyethylene homopolymer of 115,000 g/mol. The chromatographic concentrations were assumed low enough to eliminate addressing 2nd Virial coefficient effects (concentration effects on molecular weight).

The calculations of Mn, Mw, and Mz based on GPC results using the IR4 detector (Conventional GPC) and the narrow standards calibration were determined from the following equations:

$$\begin{matrix}\overline{Mn} = \frac{{\sum }^{i} {IR}_{i}}{{\sum }^{i} ( \frac{{IR}_{i}}{{M}_{PE , i}} )} , & ( 4 A ) \\ \overline{Mw} = \frac{{\sum }^{i} ( {IR}_{i} * {M}_{PE , i} )}{{\sum }^{i} {IR}_{i}} , & ( 5 A ) \\ \overline{Mz} = \frac{{\sum }^{i} ( {IR}_{i} * {M}_{PE , i}^{2} )}{{\sum }^{i} ( {IR}_{i} * {M}_{PE , i} )} & ( 6 A ) \\ \overline{Mz + 1} = \frac{{\sum }^{i} ( {IR}_{i} * {M}_{PE , i}^{3} )}{{\sum }^{i} ( {IR}_{i} * {M}_{PE , i}^{2} )} & ( 7 A )\end{matrix}$$

where IRᵢ and M_{PE,i} are the IR baseline corrected response and conventional calibrated polyethylene molecular weight for the i^{th} slice of the IR response, elution volume paired data set. The equations 4A, 5A, 6A, and 7A are calculated from polymers prepared in solutions of decalin.

The “q-factor” described previously was obtained by adjusting “q” or A is equation 1A until Mw, the weight average molecular weight calculated using equation 5A and the corresponding retention volume polynomial, agreed with the independently determined value of Mw obtained in accordance with Zimm for the broad linear polyethylene homopolymer (115,000 g/mol).

The weight percent of polymer fraction with molecular weights >10⁶ g/mol was calculated by summing the baseline corrected IR responses, IRᵢ, for the elution volume slices whose calibrated molecular weights, M_{PE,i}, were greater than 10⁶ g/mole and expressing this partial sum as a fraction of the sum of all the baseline corrected IR responses from all elution volume slices. A similar method was used to calculate the weight percentage of polymer fractions with absolute molecular weights >10⁶ and 10⁷ g/mol. The absolute molecular weight was calculated using the 15° laser light scattering signal and the IR concentration detector, M_{PE,I,abs}=K_{LS}*(LSᵢ)/(IRᵢ), using the same K_{LS} calibration constant as in equation 8A. The paired data set of the i^{th} slice of the IR response and LS response was adjusted using the determined off-set as discussed in the Systematic Approach.

In addition to the above calculations, a set of alternative Mw, Mz and M_{Z+1} [Mw (abs), Mz (abs), Mz (BB) and M_{Z+1} (BB)] values were also calculated with the method proposed by Yau and Gillespie, (Yau and Gillespie, Polymer, 42, 8947-8958 (2001)), and determined from the following equations:

$$\overline{Mw} ( abs ) = {K}_{LS} * \frac{{\sum }^{i} ( {LS}_{i} )}{{\sum }^{i} ( {IR}_{i} )} \qquad ( 8 A )$$

where, K_{LS}=LS−MW calibration constant. As explained before, the response factor, K_{LS}, of the laser detector was determined using the certificated value for the weight average molecular weight of NIST 1475 (52,000 g/mol).

$$\begin{matrix}\overline{Mz} ( abs ) = \frac{{\sum }^{i} {IR}_{i} * {( {LS}_{i} / {IR}_{i} )}^{2}}{{\sum }^{i} {IR}_{i} * ( {LS}_{i} / {IR}_{i} )} \\ & ( 9 A ) \\ \overline{Mz} ( BB ) = \frac{{\sum }^{i} ( {LS}_{i} * {M}_{PE , i} )}{{\sum }^{i} ( {LS}_{i} )} & ( 10 A ) \\ \overline{{M}_{Z + 1}} ( BB ) = \frac{{\sum }^{i} ( {LS}_{i} * {M}_{PE , i}^{2} )}{{\sum }^{i} ( {LS}_{i} * {M}_{PE , i} )} & ( 11 A )\end{matrix}$$

where LSᵢ is the 15 degree LS signal, and the M_{PE,i} uses equation 1A, and the LS detector alignment is as described previously.

In order to monitor the deviations over time, which may contain an elution component (caused by chromatographic changes) and a flow rate component (caused by pump changes), a late eluting narrow peak is generally used as a “flow rate marker peak”. A flow rate marker was therefore established based on a decane flow marker dissolved in the eluting sample prepared in TCB. This flow rate marker was used to linearly correct the flow rate for all samples by alignment of the decane peaks. For samples dissolved in decalin, the decalin solvent gave a huge spike in the elution curve which overflowed the IR-4 detector therefore no decane peak can be used as flow rate marker. In order to minimize the effect caused by flow rate change, the flow characteristics of the linear polyethylene homopolymer (115,000 g/mol) prepared in TCB with decane as the flow rate marker was used as the same flow characteristics for solution samples prepared in decalin run on the same carousal.

Swell

The resin swell is expressed as the time required by an extruded polymer strand to travel a pre-determined distance of 230 mm. The Gottfert Rheograph 2003, equipped with a 12 mm inner diameter (ID) barrel, a 1 mm ID capillary die with a 10 mm land (L/D=10) and a 180° entrance angle is used for the measurement. The measurement is carried out at 190° C., at two fixed shear rates, 300 s⁻¹ and 1,000 s⁻¹, respectively. Once the rheometer program begins the polymer strand is cut flush with the die holder and the timer is started. The more the resin swells, the slower the free strand end travels and, the longer it takes to cover 230 mm. The swell is reported as t300 and t1000 (s) values, the time required by the extruded polymer strand to travel 230 mm at shear rates of 300 s⁻¹ and 1,000 s⁻¹ respectively.

Rheology

The sample is compression molded into a disk for rheology measurement. The disks are prepared by pressing the samples into 0.071″ (1.8 mm) thick plaques, and are subsequently cut into 1 in (25.4 mm) disks. The compression molding procedure is as follows: 365° F. (185° C.) for 5 min at 100 psi (689 kPa); 365° F. (185° C.) for three minutes, at 1500 psi (10.3 MPa); cooling at 27° F. (15° C.)/min to ambient temperature (about 23° C.).

The resin rheology is measured on the ARES I (Advanced Rheometric Expansion System) Rheometer. The ARES is a strain controlled rheometer. A rotary actuator (servomotor) applies shear deformation in the form of strain to a sample. In response, the sample generates torque, which is measured by the transducer. Strain and torque are used to calculate dynamic mechanical properties such as modulus and viscosity. The viscoelastic properties of the sample are measured in the melt, using a parallel plate set up, at constant strain (5%) and temperature (190° C.), and as a function of varying frequency (0.01 to 100 or 500 s⁻¹). The storage modulus (G′), loss modulus (G″), tan delta, and complex viscosity (eta*) of the resin are determined using Rheometrics Orchestrator software (v. 6.5.8).

Tensile Properties

Tensile strength at yield, elongation at yield, tensile strength at break, elongation at break and tensile modulus were determined according to ASTM D-638 with a test speed of two inches per minute. All measurements were performed at 23° C. on rigid type IV specimens, which were compression molded per ASTM D 4703, Annex A-I, with a 5 minute initial heating period at about 190° C. (+2° C.), and a 15° C./min cooling rate per Procedure C. The specimen was cooled to 45° C. in the press, with continued cooling until “cool to the touch.”

Tensile creep was measured on ASTM D638 Type 1 compression molded plaques at 60° C. at 2 MPa stress in accordance with the ASTM D2990 method. The tensile creep measurement was performed on the Applied Test System, single zone temperature control, 2010 Series equipment. The ASTM D638 Type 1 dog bone geometry samples were mounted in individual temperature controlled chambers. The sample dimensions were measured and a stress level of 2.0 MPa was applied to each sample. The temperature of the chamber was set at 60° C. LVDT transducers monitored and measured vertical deformation of the sample under constant stress and temperature over time. The test equipment software captured the sample displacement, temperature and time signals.

Shrink was measured on injection molded samples per ASTM D955.

Charpy Impact was measured in accordance with ISO 179 at −40° C.

Vicat softening point (° C.) was measured in accordance with ASTM D1525.

The vinyl/1000 C content was measured according to ASTM D6248.

Environmental Stress Crack Resistance (ESCR)

The resin environmental stress crack resistance (ESCR) was measured per ASTM D 1693, Method B, in 10% aqueous Igepal CO-630 solution. Specimens were molded according to ASTM D 4703 Annex A, with a 5 min initial heating period at about 190° C. and a 15° C./min cooling rate per Procedure C. The specimen was cooled to 45° C. in the press, with continued cooling until cool to the touch. As used herein, “Igepal” is Octylphenoxy Poly(Ethyleneoxy)Ethanol, Branched.

In this test, the susceptibility of a resin to mechanical failure by cracking is measured under constant strain conditions, and in the presence of a crack accelerating agent such as, soaps, wetting agents, and the like. Measurements were carried out on notched specimens, in a 10% by volume Igepal CO-630 (available from Rhone-Poulenc Co., Inc.) aqueous solution, maintained at 50° C. Ten specimens were evaluated per measurement. The ESCR value of the resin is reported as F50, the calculated 50% failure time from the probability graph. If no sample failures occurred during 1000 h from the start of the test, the measurement was stopped and the F50 value reported as >1000 h.

### Inventive Polyethylene Composition Examples and Comparative Examples

Two examples of the inventive compositions, Inventive Examples 1 and 2, were produced and analyzed as shown in the following tables. The catalyst used to produce the inventive examples is described below.

Preparation of Catalyst Precursor

A titanium trichloride catalyst precursor is prepared in a vessel equipped with pressure and temperature control, and a turbine agitator. A nitrogen atmosphere (<5 ppm H₂O) is maintained at all times. Tetrahydrofuran (10,500 lbs, 4,800 kg, <400 ppm H₂O) is added to the vessel. The tetrahydrofuran (THF) used is recovered from a closed cycle dryer and contains approximately 0.1 percent Mg and 0.3 percent Ti. An 11 percent THF solution of triethylaluminum is added to scavenge residual water. The reactor contents are heated to 40° C., and 13.7 lbs (6 kg) of granular magnesium metal (particle size 0.1-4 mm) is added, followed by 214.5 lbs (97.3 kg) of titanium tetrachloride added over a period of one-half hour.

The mixture is continuously agitated. The exotherm resulting from the addition of titanium tetrachloride causes the temperature of the mixture to rise to approximately 44° C. The temperature is then raised to 70° C. and held at that temperature for approximately four hours, then cooled to 50° C. At the end of this time, 522 pounds (238 kg) of magnesium dichloride are added and heating initiated to raise the temperature to 70° C. The mixture is held at this temperature for another five hours, then cooled to 35° C. and filtered through a 100 mesh (150 μm) filter to remove undissolved solids.

Fumed silica (CAB-O-SIL™ TS-610, manufactured by and available from the Cabot Corporation) (811 lbs, 368 kg) is added to the above precursor solution over a period of one hour. The mixture is stirred by means of a turbine agitator during this time and for 4 hours thereafter to thoroughly disperse the silica. The temperature of the mixture is held at 40° C. throughout this period and a dry nitrogen atmosphere is maintained at all times. The resulting slurry is spray dried using an 8-foot diameter closed cycle spray dryer equipped with a rotary atomizer. The rotary atomizer is adjusted to give catalyst particles with a D50 on the order of 20-30 μm. The scrubber section of the spray dryer is maintained at approximately +5 to −5° C.

Nitrogen gas is introduced into the spray dryer at an inlet temperature of 140 to 165° C. and is circulated at a rate of approximately 1000-1800 kg/hour. The catalyst slurry is fed to the spray dryer at a temperature of about 35° C. and a rate of 65-150 kg/hour, or sufficient to yield an outlet gas temperature in the range of 100-125° C. The atomization pressure is maintained at slightly above atmospheric. The resulting catalyst particles are mixed with mineral oil under a nitrogen atmosphere in a vessel equipped with a turbine agitator to form a slurry containing approximately 28 percent of the catalyst precursor.

Catalyst Precursor Partial Pre-Activation

The mineral oil slurry of precursor is partially activated by contact at room temperature with an appropriate amount of a 50 percent mineral oil solution of tri-n-hexyl aluminum (TNHA). The catalyst precursor slurry is added to a mixing vessel. While stirring a 50 percent mineral oil solution of TNHA is added at ratio of 0.17 moles of TNHA to mole of residual THF in the precursor and stirred for at least 1 hour prior to use.

### Inventive Example Production

Ethylene is copolymerized with 1-hexene in two fluidized bed reactors. Each polymerization is continuously conducted after equilibrium is reached under the respective conditions, as shown in Table 2 below. Polymerization is initiated in the first reactor by continuously feeding the catalyst and cocatalyst (trialkyl aluminum specifically tri ethyl aluminum or TEAL) into a fluidized bed of polyethylene granules, together with ethylene, 1-hexene and hydrogen. The resulting copolymer, mixed with active catalyst, is withdrawn from the first reactor and transferred to the second reactor, using second reactor gas as a transfer medium. The second reactor also contains a fluidized bed of polyethylene granules. Ethylene and hydrogen are introduced into the second reactor, where the gases come into contact with the polymer and catalyst from the first reactor. Inert gases, nitrogen and isopentane, make up the remaining pressure in both the first and second reactors. In the second reactor, the TEAL cocatalyst is again introduced. The final product composition is continuously removed.

Table 2 gives the process conditions used to make the inventive examples.

TABLE 2

| | Inv. Ex #1 | | Inv. Ex. #2 | |
|---|---|---|---|---|
| Process Conditions | Reactor 1 | Reactor 2 | Reactor 1 | Reactor 2 |
| Temp. ° C. | 75 | 110 | 75 | 110 |
| Pressure, psig | 347 | 394 | 347 | 393 |
| C2 Part. Pressure, psi | 30 | 87 | 28 | 74 |
| H2/C2 Molar Ratio | 0.036 | 1.80 | 0.056 | 1.79 |
| C6/C2 Molar Ratio | 0.070 | 0.000 | 0.024 | 0.000 |
| Isopentane mole % | 9.53 | 0.38 | 10.31 | 0.39 |
| Production Rate, lb/hr | 25.0 | 15.9 | 30.0 | 19.6 |
| Bed Weight, lbs | 81.1 | 77.4 | 80.8 | 77.1 |
| Weight % | 61% | | 60% | |

Table 3 illustrates properties of the first and second components of Inventive Examples 1 and 2 as well as fundamental properties of the compositions of Inventive Examples 1 and 2.

TABLE 3

| | | Inv. Ex. 1 | Inv. Ex. 2 |
|---|---|---|---|
| First | High Load Melt | 0.33 | 0.32 |
| Component | Index (I₂₁) g/10 min | | |
| | Density g/cc | 0.925 | 0.932 |
| | Weight % | 61 | 60 |
| Second | Melt Index (I₂) g/10 min | ~1200 | ~1200 |
| Component* | Density g/cm³ | ~0.975 | ~0.975 |
| Inventive | High Load Melt | 5.8 | 5.7 |
| Composition | Index (I₂₁) g/10 min | | |
| | Melt Index (I₅) g/10 min | 0.25 | 0.26 |
| | MFR (I₂₁/I₅) | 23 | 23 |
| | Density g/cc | 0.947 | 0.953 |

*Melt Index (I₂) and density of the second component were not measured but rather were estimated as discussed herein.

Large size compounded samples of the inventive examples were produced by melt extrusion of the inventive example polymer powder with antioxidant and catalyst neutralizer. The melt extrusion was carried out on a Kobe LCM 100 extruder equipped with EL-2 rotors. The antioxidants were 0.1 weight percent IRGANOX 1010 (available from Ciba, a BASF subsidiary) and 0.1 weight percent IRGAFOS 168 (available from Ciba, a BASF subsidiary). The acid neutralizer was 0.055 weight percent calcium stearate. Typical extrusion conditions were 180° C. barrel set point temperature. The inventive powders were fed at ambient temperature. The extruder screw speed was typically 220 rpm; resin feed rate 550 lb/h; and the melt pump suction pressure 7 psig.

The properties of Inventive Examples 1 and 2 were compared to Comparative Example 1. Comparative Example 1 is a commercial high molecular weight high density polyethylene resin sold by LyondellBasell under the trade name LUPOLEN 4261 AG (0.9464 g/cc density, 6.7 g/10 min I₂₁, 21 I₂₁/I₅).

Table 4 illustrates the swell and viscoelastic properties of Inventive Examples 1 and 2 and Comparative Example 1.

TABLE 4

| | Low Shear Rheology | | | | Capillary Extrudate | |
|---|---|---|---|---|---|---|
| | | η *@ 0.02 s⁻¹/ | | | Swell | |
| | η*@ 0.02 s⁻¹ | η *@ 200 s⁻¹ | tan ō @ | tan ō @ 0.02 s⁻¹/ | t300 av | t1000 av |
| | Pa s | Pa s | 0.02 s⁻¹ | tan ō @ 200 s⁻¹ | s | s |
| Inv. Ex. 1 | 164,890 | 96 | 2.29 | 5.53 | 15.4 | 4.5 |
| Inv. Ex. 2 | 146,709 | 88 | 2.44 | 5.93 | 14.8 | 4.3 |
| Comp. Ex. 1 | 186,307 | 116 | 1.51 | 2.87 | 29.4 | 8.7 |

Table 5 illustrates the vinyl content and molecular weight characteristics of Inventive Examples 1 and 2 and Comparative Example 1.

TABLE 5

| | | |
|---|---|---|
| Inv. Ex 1 | Inv. Ex 2 | Comp Ex 1 |

Unsaturation Measurement

| | | | |
|---|---|---|---|
| Vinyls/1000 C. | Not measured | 0.139 | 0.928 |

MWD Determination

| | | | |
|---|---|---|---|
| IR-GPC | | | |
| Mₙ | 9,500 | 9,770 | 12,330 |
| M_{w} | 205,350 | 207,500 | 214,280 |
| M_{z} | 840,400 | 817,600 | 1,095,700 |
| M_{w}/Mₙ | 21.6 | 21.2 | 17.4 |
| LS GPC | | | |
| Mₙ | 9,285 | 9,382 | 11,857 |
| M_{w} | 252,620 | 249,780 | 226,740 |
| M_{w}(LS)/Mₙ(IR) | 26.6 | 25.6 | 18.4 |
| M_{z}(BB) | 934,300 | 911,800 | 1,123,900 |
| M_{z} (Abs) | 1,288,600 | 1,160,400 | 1,132,800 |
| M_{z+1}(BB) | 1,643,900 | 1,677,400 | 2,403,800 |
| M_{z}(Abs)/M_{w} | 5.1 | 4.7 | 5.0 |
| M_{z+1}/M_{w} | 6.5 | 6.7 | 10.6 |

Table 6 illustrates the shrinkage behavior of Inventive Examples 1 and 2 and Comparative Example 1.

TABLE 6

| | Mold Shrinkage | | Post Shrinkage | |
|---|---|---|---|---|
| | Flow | Gross Flow | Cross Flow | Flow |
| | Shrinkage | Shrinkage | Shrinkage | Shrinkage |
| Sample | (%) | (%) | (%) | (%) |
| Inv. Ex. 1 | 3.3 | 1.1 | 0.5 | 1.5 |
| Inv. Ex. 2 | 3.2 | 1.1 | 0.5 | 1.4 |
| Comp. Ex. 1 | 2.8 | 1.2 | 0.8 | 1.5 |

Table 7 illustrates the mechanical properties of Inventive Examples 1 and 2 and Comparative Example 1.

TABLE 7

| | | | | Comp. |
|---|---|---|---|---|
| | Units | Inv. Ex. 1 | Inv. Ex. 2 | Ex. 1 |
| ESCR F50, notched | hours | >1000 | >1000 | >1000 |
| plaque, 10% Igepal | (h) | | | |
| CO 630 F50 (no | | | | |
| breaks, measurement | | | | |
| stopped after 1000 h) | | | | |
| Charpy Impact @ | kJ/m² | 23.8 | 24.9 | 17.7 |
| (−40° C.) | | | | |
| Tensile Properties | | | | |
| Yield Stress | psi | 3,577 | 4,036 | 3,459 |
| | (kPa) | (24,670) | (27,835) | (23,856) |
| Yield Strain | % | 10.3 | 10.1 | 11.6 |
| Stress at Break | psi | 4,671 | 5,492 | 5,605 |
| | (kPa) | (32,215) | (37,777) | (38,656) |
| Strain at Break | % | 990 | 1061 | 1259 |
| Elongation at Break | in | 9.9 | 10.6 | 12.6 |
| Tensile Modulus | psi | 140,378 | 139,781 | 102,492 |
| | (kPa) | (968,154) | (963,829) | (706,863) |
| Vicat Softening Point | ° C. | 128.8 | 131.1 | 128.5 |

Table 8 illustrates the creep strain of Inventive Examples 1 and 2 and Comparative Example 1 measured at 2 MPa and 60° C.

TABLE 8

Creep Strain %

| Sample | No of measurements | Average | Std. dev. |
|---|---|---|---|
| Inv. Ex. 1 | 5 | 1.68 | 0.033 |
| Inv. Ex. 2 | 6 | 1.33 | 0.033 |
| Comp. Ex. 1 | 4 | 1.81 | 0.053 |

We claim:

1. A fuel container comprising:
a polyethylene composition comprising:
a first component comprising an ethylene-based interpolymer, wherein the first component is a heterogeneously branched linear or a homogeneously branched linear ethylene-based interpolymer, having a density from 0.922 g/cc to 0.945 g/cc, and a high load melt index I₂₁ between 0.1 and 1 g/10 min; and
a second component comprising an ethylene-based polymer,
wherein the polyethylene composition has a density in the range of from 0.937 to 0.960 g/cc and a high load melt index I₂₁ in the range of from 3 to 15 g/10 min.

2. The fuel container of claim 1, wherein the polyethylene composition exhibits a creep strain, measured according to ASTM D2990 at 60° C. and 2 MPa, of less than or equal to 1.8 percent.

3. The fuel container of claim 1, wherein the polyethylene composition exhibits an environmental stress crack resistance of greater than 1000 hours according to ASTM D1693, method B, in 10 percent aqueous Igepal (Octylphenoxy Poly(Ethyleneoxy)Ethanol, Branched) CO-630, a Charpy Impact measured according to ISO-179 at −40° C. of at least 18 kJ/m², and a tensile modulus measured according to ASTM D638 of at least 105,000 psi.

4. The fuel container of claim 1, wherein the first component is an ethylene/α-olefin interpolymer.

5. The fuel container of claim 4, wherein the α-olefin is selected from the group consisting of 1-butene, 1-pentene, 1-hexene, 1-heptene, 1-octene, 1-nonene, and 1-decene.

6. The fuel container of claim 1, wherein the first component comprises between 50 wt % and 70 wt % of the total weight of the polyethylene composition.

7. The fuel container of claim 1, wherein the polyethylene composition has a density in the range of from 0.945 to 0.958 g/cc.

8. The fuel container of claim 1, wherein the polyethylene composition has a high load melt index I₂₁ in the range of from 3 to 8 g/10 min.

9. The fuel container of claim 1, further comprising one or more additives selected from the group consisting of fillers, UV stabilizers, and pigments.

10. The fuel container of claim 1, wherein the container is a vehicle fuel tank.

11. A process for blow molding a polyethylene composition into a fuel container comprising: extruding a polyethylene composition having a density in the range of from 0.937 to 0.960 g/cc and a high load melt index I₂₁ in the range of from 3 to 15 g/10 min and comprising a first component comprising an ethylene-based interpolymer, wherein the first component is a heterogeneously branched linear or a homogeneously branched linear ethylene-based interpolymer, having a density from 0.922 g/cc to 0.945 g/cc, and a high load melt index I₂₁ between 0.1 and 1 g/10 min and a second component comprising an ethylene-based polymer and optionally a filler, in an extruder through a die; forming a molten tube-shaped parison, holding the parison within a shaping mold; blowing a gas into the mold so as to shape the parison according to a profile of the mold; and yielding a blow molded article in a shape for use as a fuel container.

12. A method for preparing a polyethylene composition comprising a first component ethylene-based interpolymer and a second component ethylene-based polymer (interpolymer or homopolymer) comprising:
a) polymerizing either the first component ethylene-based interpolymer, or the second component ethylene-based polymer (interpolymer or homopolymer), in a first reactor, in the presence of a Ziegler-Natta catalyst system, to form a first polymer product;
b) transferring the first polymer product to a second reactor; and
c) polymerizing, in the second reactor, the ethylene-based polymer that was not produced in the first reactor, in the presence of the Ziegler-Natta catalyst system;
wherein the first component is a heterogeneously branched linear ethylene-based interpolymer, and has a density from 0.922 g/cc to 0.945 g/cc, and a high load melt index I₂₁ from 0.1 g/10 min to 1 g/10 min; and
wherein the polyethylene composition has a density in the range of from 0.937 to 0.960 g/cc and a high load melt index I₂₁ in the range of from 3 to 15 g/10 min.
